(19) United States
(12) Patent Application Publication
(10) Pub. No.: US 2025/0387794 A1
(43) Pub. Date: Dec. 25, 2025

(54) WATER DISCHARGING DEVICE

(71) Applicant: LIXIL Corporation, Tokyo (JP)

(72) Inventors: Kengo FUJII, Tokyo (JP); Noritoshi OTA, Tokyo (JP); Ririka HAYAKAWA, Tokyo (JP)

(73) Assignee: LIXIL Corporation, Tokyo (JP)

(21) Appl. No.: 18/842,358

(22) PCT Filed: Dec. 27, 2022
(86) PCT No.: PCT/JP2022/048242

§ 371 Date: Mar. 31, 2025

(30) Foreign Application Priority Data
Mar. 2, 2022 (JP) 2022-031412

(51) Int. Cl. B05B 1/18; B05B 1/16; E03C 1/04

(52) U.S. Cl. CPC B05B 1/182; B05B 1/16; E03C 1/0404

(57) ABSTRACT

A water discharging device (10) includes a raw water discharging part (14) and a reformed water discharging part (12). The raw water discharging part (14) is capable of discharging raw water supplied from a water supply source by switching a water discharging form between a spray form and a stream form. The reformed water discharging part (12) discharges reformed water obtained by reforming the raw water. The raw water discharging part (14) is disposed around the reformed water discharging part (12) so as to surround the reformed water discharging part (12).

### CROSS-REFERENCE TO RELATED APPLICATIONS

This application is a national stage application under 35 USC 371 of International Application No. PCT/JP2022/048242, filed Dec. 27, 2022, which claims the priority of Japanese Application No. 2022-031412, filed Mar. 2, 2022. The entire contents of each priority application are incorporated herein by reference.

### FIELD

The present disclosure relates to a water discharging device.

### BACKGROUND

JP 2017-20305 A discloses a known water discharging device. The water discharging device discharges raw water supplied from a water supply source. This water discharging device can switch a water discharging form between a spray form and a stream form, and thus has high convenience.

### SUMMARY

### Technical Problems

As a water discharging device, a device capable of not only switching the water discharging form but also discharging water different in property from the raw water, such as reformed water obtained by subjecting the raw water to some treatment, is also known. In a case where the water discharging device disclosed in JP 2017-20305 A is additionally equipped with such a capability, it is ideal that the flow paths and water discharging ports for the raw water and the reformed water be each separately provided from the viewpoint of quality of the reformed water. This configuration, however, requires the flow path and the water discharging port for the reformed water in addition to the configurations for spray water discharge and stream water discharge, and thus there is a concern about an increase in size of the device.

The present disclosure has been made in view of the above-described conventional circumstances, and it is therefore an object of the present disclosure to provide a water discharging device capable of suppressing an increase in size while ensuring convenience and quality of reformed water.

### Solutions to Problems

In order to solve the above-described problems, a water discharging device according to an embodiment of the present disclosure includes a raw water discharging part capable of discharging raw water supplied from a water supply source by switching a water discharging form between a spray form and a stream form, and a reformed water discharging part that discharges reformed water obtained by reforming the raw water. The raw water discharging part is disposed around the reformed water discharging part so as to surround the reformed water discharging part.

### BRIEF DESCRIPTION OF DRAWINGS

FIG. 1 is a schematic perspective view of a faucet device including a water discharging device according to a first embodiment.

FIG. 2 is a schematic side view of the faucet device including the water discharging device according to the first embodiment, with the faucet device partially illustrated in cross section.

FIG. 3 is a cross-sectional view of the water discharging device according to the first embodiment.

FIG. 4 is an enlarged cross-sectional view of a main part of the water discharging device according to the first embodiment.

FIG. 5 is an exploded perspective view of the water discharging device according to the first embodiment.

FIG. 6 is a diagram illustrating the water discharging device according to the first embodiment, corresponding to a view taken along arrow VI-VI in FIG. 2.

FIG. 7 is an enlarged cross-sectional view of the main part of the water discharging device according to the first embodiment, illustrating a state where a water spraying member is at a first position.

FIG. 8 is an enlarged cross-sectional view of the main part of the water discharging device according to the first embodiment, illustrating a state where the water spraying member is at a second position.

FIG. 9 is a diagram for describing how the water discharging device according to the first embodiment operates.

FIG. 10 is an enlarged cross-sectional view of a main part of a water discharging device according to a second embodiment.

FIG. 11 is an enlarged cross-sectional view of a main part of a water discharging device according to a third embodiment.

FIG. 12 is an enlarged cross-sectional view of a main part of a water discharging device according to a fourth embodiment.

FIG. 13 is an enlarged perspective cross-sectional view of a main part of a water discharging device according to a fifth embodiment, illustrating a state where a water spraying member is at a first position.

FIG. 14 is an enlarged perspective cross-sectional view of the main part of the water discharging device according to the fifth embodiment, illustrating a state where the water spraying member is at a second position.

FIG. 15 is an enlarged perspective cross-sectional view of a main part of a water discharging device according to a sixth embodiment, illustrating a state where a water spraying member is at a first position.

FIG. 16 is an enlarged perspective cross-sectional view of the main part of the water discharging device according to the sixth embodiment, illustrating a state where the water spraying member is at a second position.

### DETAILED DESCRIPTION

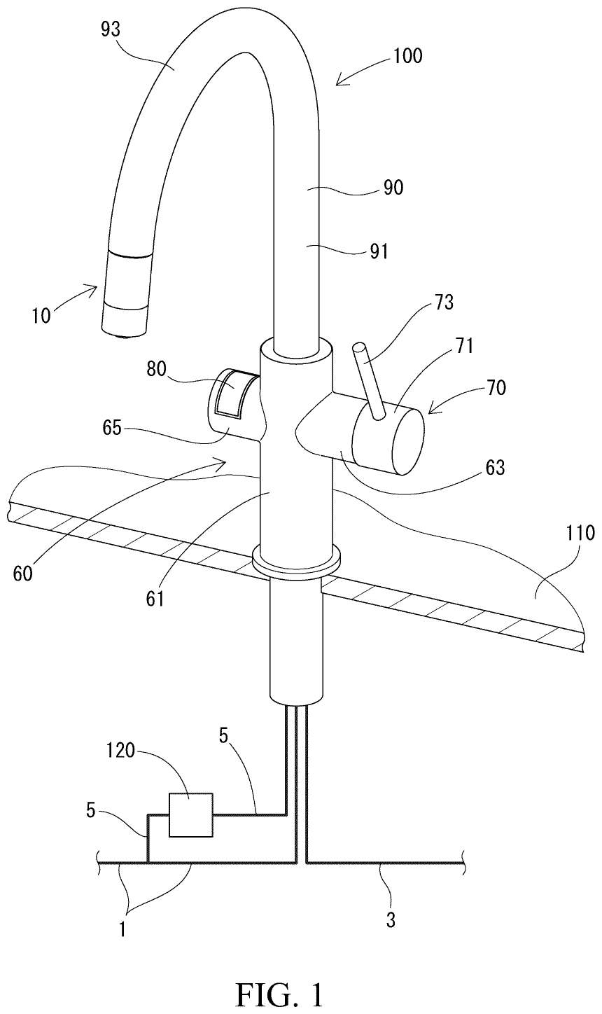

First to sixth embodiments each embodying a water discharging device according to the present disclosure will be described with reference to the drawings. In the following description of each embodiment, a form in which each water discharging device is attached to a kitchen counter 110 illustrated in FIG. 1 will be given as an example.

### First Embodiment

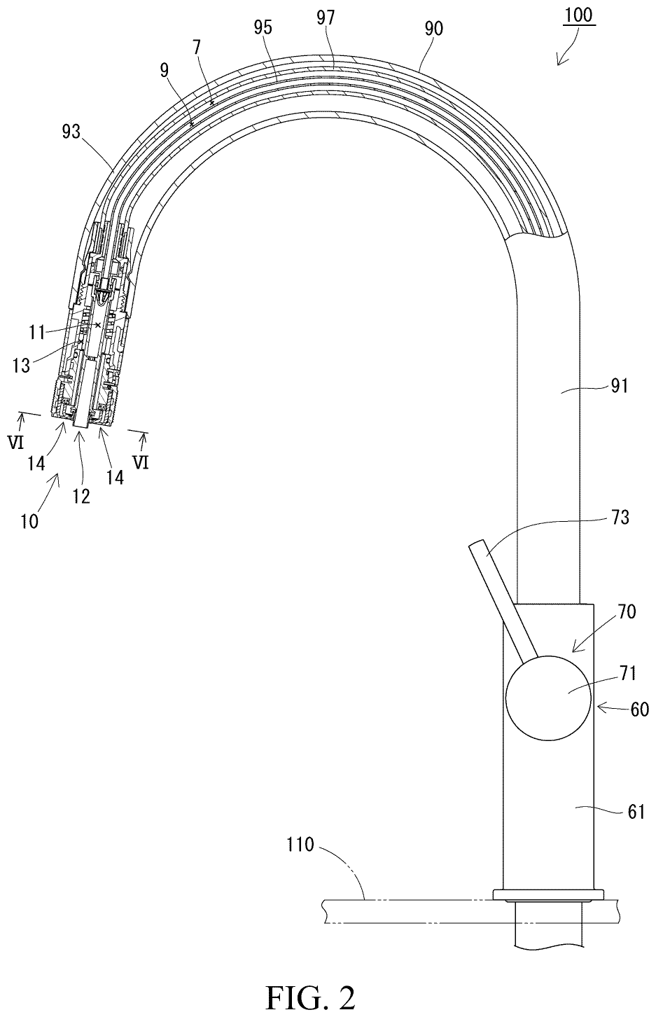

As illustrated in FIGS. 1 and 2, a water discharging device 10 according to the first embodiment is connected to a downstream end of a water discharging pipe 90 in a faucet device 100. The faucet device 100 is attached to the kitchen counter 110. The faucet device 100 includes a faucet main body 60, a raw water operating part 70, a reformed water operating part 80, the water discharging pipe 90, and the water discharging device 10. A water supply path 1 communicating with a water supply source, a hot water supply path 3 communicating with a hot water supply source, and a branch path 5 branching from the water supply path 1 and connected to a reformed water generator 120 located in the middle of the branch path 5 each pass through the faucet device 100, and cold water, hot water, and reformed water flow therethrough. The reformed water generator 120 generates reformed water, such as purified water, obtained by reforming raw water.

The faucet device 100 discharges, as raw water, either a mixture of the water flowing in through the water supply path 1 and the hot water flowing in through the hot water supply path 3 or unmixed water, from a raw water discharging part 14 to be described later of the water discharging device 10. The faucet device 100 can discharge reformed water generated by the reformed water generator 120 from a reformed water discharging part 12 to be described later of the water discharging device 10.

The faucet main body 60 includes a center main body part 61, a right main body part 63, and a left main body part 65. When the faucet main body 60 is attached to the kitchen counter 110, the center main body part 61 linearly extends in a vertical direction from an upper surface of the kitchen counter 110, and the center main body part 61 has a cylindrical outer shape. When the faucet main body 60 is attached to the kitchen counter 110, the right main body part 63 and the left main body part 65 extend in a left-right direction relative to the center main body part 61, and the right main body part 63 and the left main body part 65 each have a cylindrical outer shape. A center axis of the right main body part 63 and a center axis of the left main body part 65 extend in a horizontal direction on the same straight line.

The faucet main body 60 has a mixing valve with a water shutoff function (not illustrated) incorporated into the right main body part 63. The mixing valve with a water shutoff function has two inflow ports respectively communicating with the water supply path 1 and the hot water supply path 3, and has one outflow port communicating with a raw water supply path 7 of the water discharging pipe 90. The mixing valve with a water shutoff function opens/closes flow paths connecting the water supply path 1 and the hot water supply path 3 with the raw water supply path 7, changes a flow rate of raw water flowing out to the raw water supply path 7, or changes a flow temperature by changing a mixing ratio between water flowing in through the water supply path 1 and hot water flowing in through the hot water supply path 3.

The raw water operating part 70 is attached to a right end of the right main body part 63 of the faucet main body 60. The raw water operating part 70 includes an operating part main body 71 and an operating lever 73. The operating part main body 71 is provided coaxially with the right main body part 63 and has a cylindrical outer shape. The operating lever 73 extends radially outward from an outer peripheral surface of the operating part main body 71. The raw water operating part 70 is linked to a movable part of the mixing valve with a water shutoff function. By the operation of the operating lever 73, the faucet device 100 can switch between discharge and shutoff of the raw water from the raw water discharging part 14, change a water discharge flow rate, or change a water discharge temperature.

The reformed water operating part 80 is a contact sensor and is provided in the left main body part 65 of the faucet main body 60. The reformed water operating part 80 is connected to the reformed water generator 120 to be described later so as to send a signal to the reformed water generator 120. In the faucet device 100, when the reformed water operating part 80 is operated, the reformed water generator 120 generates reformed water. The reformed water generated by the reformed water generator 120 is discharged from the reformed water discharging part 12 through a reformed water supply path 9.

The water discharging pipe 90 is provided at an upper end of the center main body part 61 of the faucet main body 60 so as to rotate freely about a center axis of the center main body part 61. The water discharging pipe 90 has an upstream part 91 and a downstream part 93. The upstream part 91 linearly extends upward in the vertical direction from the upper end of the center main body part 61. The downstream part 93 is curved in an arc shape projecting upward from an upper end of the upstream part 91. A downstream end opening of the water discharging pipe 90 faces downward.

The raw water supply path 7 and the reformed water supply path 9 are arranged inside the water discharging pipe 90. The raw water supply path 7 communicates with the water supply path 1 and the hot water supply path 3 via the mixing valve with a water shutoff function (not illustrated) and allows the raw water passing through the mixing valve to flow through the raw water supply path 7. The reformed water supply path 9 directly communicates with the branch path 5 and allows the reformed water generated by reformed water generator 120 to flow through the reformed water supply path 9.

In the present embodiment, as illustrated in FIG. 2, the raw water supply path 7 and the reformed water supply path 9 are formed by two flexible tubes 95 and 97 inserted into the water discharging pipe 90. The two flexible tubes 95 and 97 form a double pipe and form two flow paths. The reformed water supply path 9 is formed in the inner flexible tube 95. The raw water supply path 7 is formed between the inner flexible tube 95 and the outer flexible tube 97. The flexible tubes 95 and 97 can be pulled out from the downstream end of the water discharging pipe 90 together with the water discharging device 10 removed from the downstream end of the water discharging pipe 90.

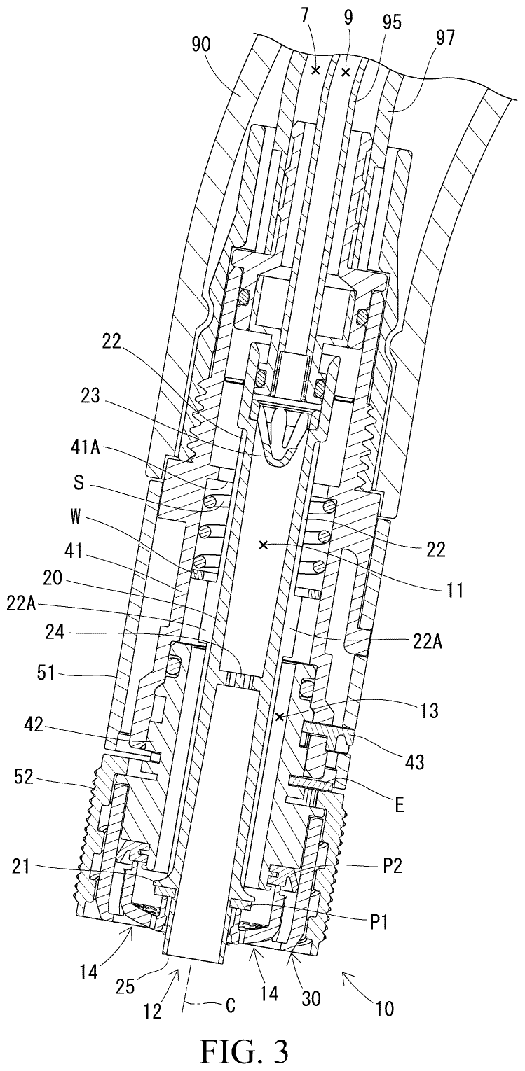

As illustrated in FIG. 3, the water discharging device 10 has a cylindrical shape centered on an axis C as a whole. The water discharging device 10 is attached to the water discharging pipe 90 at its one end in an axial direction and discharges the reformed water and the raw water from the other end in the axial direction. The water discharging device 10 is detachably attached to the downstream end of the water discharging pipe 90. The water discharging device 10 can be used while being pulled out together with the flexible tubes 95 and 97 from the downstream end of the water discharging pipe 90. In the following description, the water discharging pipe 90 side, which is one end side in the axial direction in the water discharging device 10, is also referred to as an upstream side, and the other side is also referred to as a downstream side.

The water discharging device 10 includes a reformed water flow path 11, the reformed water discharging part 12, a raw water flow path 13, and the raw water discharging part 14. The reformed water flow path 11 communicates, at its upstream end, with the reformed water supply path 9 on the water discharging pipe 90 side and allows the reformed water flowing in from the reformed water supply path 9 to flow through the reformed water flow path 11. The reformed water discharging part 12 discharges the reformed water flowing through the reformed water flow path 11. The raw water flow path 13 communicates, at its upstream end, with the raw water supply path 7 on the water discharging pipe 90 side and allows the raw water flowing in from the raw water supply path 7 to flow through the raw water flow path 13. The raw water discharging part 14 discharges the raw water flowing through the raw water flow path 13. The raw water discharging part 14 is disposed around the reformed water discharging part 12 so as to surround the reformed water discharging part 12.

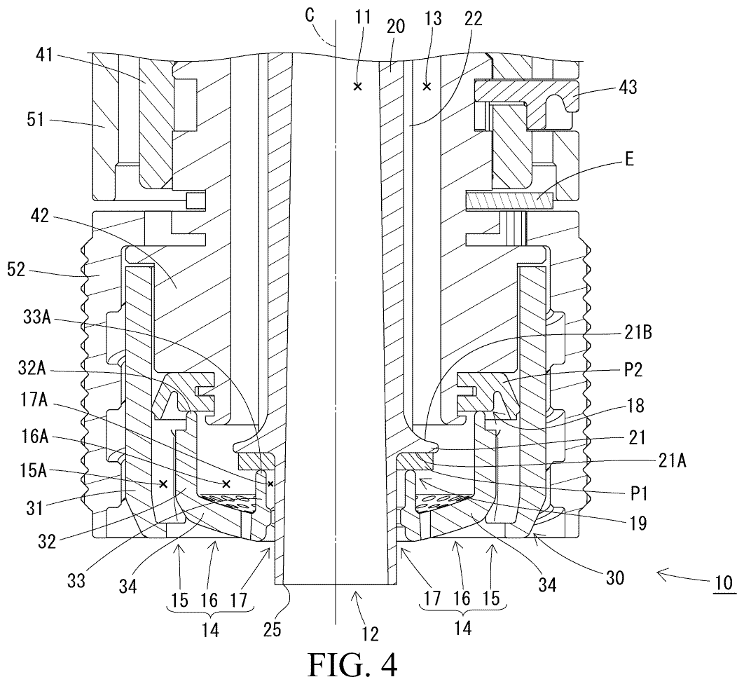

As illustrated in FIG. 4, the raw water discharging part 14 includes a first stream water discharging part 15, a spray water discharging part 16, and a second stream water discharging part 17. The first stream water discharging part 15, the spray water discharging part 16, and the second stream water discharging part 17 form, with a water spraying member 30, respective tubular regions concentrically arranged. The first stream water discharging part 15 is an example of a stream water discharging part according to the present disclosure. The first stream water discharging part 15 discharges the raw water when the water discharging form of the raw water discharging part 14 is a stream form. The spray water discharging part 16 discharges the raw water when the water discharging form of the raw water discharging part 14 is a spray form. The spray water discharging part 16 is disposed with being surrounded by the first stream water discharging part 15. The second stream water discharging part 17 discharges the raw water together with the first stream water discharging part 15 when the water discharging form of the raw water discharging part 14 is the stream form.

As illustrated in FIG. 4, the water discharging device 10 includes a first opening/closing part 18 and a second opening/closing part 19. The first opening/closing part 18 is an example of an opening/closing part according to the present disclosure. The first opening/closing part 18 opens/closes a first stream flow path 15A communicating with the first stream water discharging part 15. The first stream flow path 15A is an example of a stream flow path according to the present disclosure. The second opening/closing part 19 opens/closes a second stream flow path 17A communicating with the second stream water discharging part 17. In the water discharging device 10, the first opening/closing part 18 and the second opening/closing part 19 open/close the first stream flow path 15A and the second stream flow path 17A, respectively, thereby switching the water discharging form between the spray form and the stream form.

As illustrated in FIGS. 3 to 5, the water discharging device 10 includes, as components, a pipe member 20, the water spraying member 30, a first inner cylinder member 41, a second inner cylinder member 42, a first outer cylinder member 51, a second outer cylinder member 52, and the like. These components are all arranged coaxially with respect to the axis C. The pipe member 20 is formed in a tubular shape. The pipe member 20 is disposed with its center axis coincident with the axis C. The pipe member 20 is connected, at its upstream end, to the flexible tube 95 forming the reformed water supply path 9. A space inside an inner peripheral surface of the pipe member 20 is the reformed water flow path 11. The pipe member 20 forms, outside its outer peripheral surface, a space to be the raw water flow path 13. That is, the water discharging device 10 has two flow paths formed by a double pipe as with the configuration of the water discharging pipe 90.

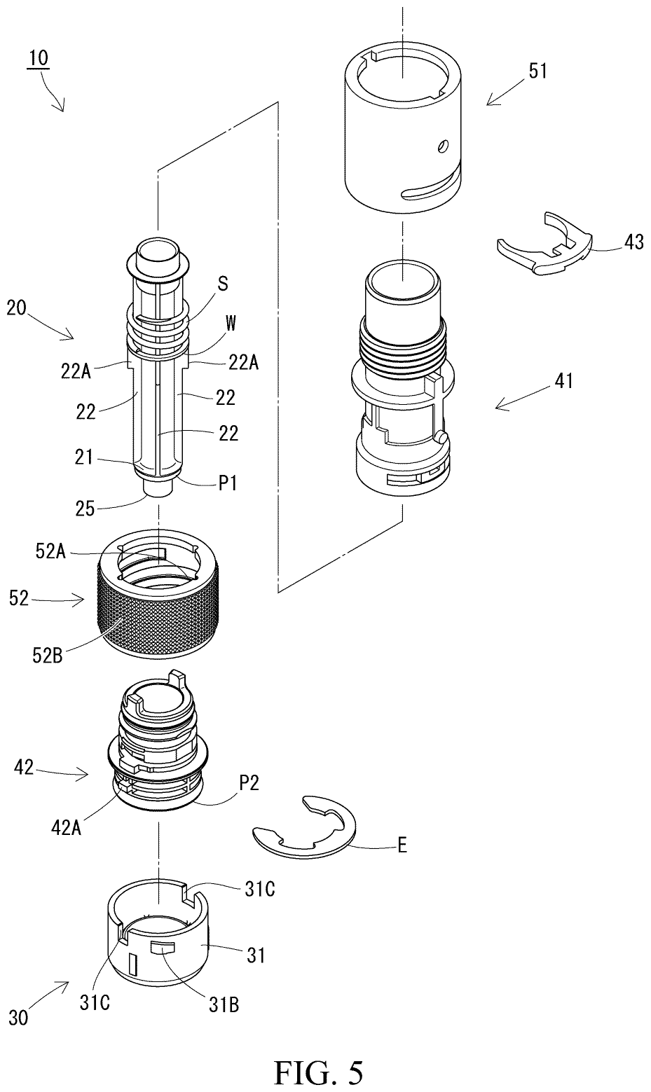

As illustrated in FIG. 5, the pipe member 20 has a flange part 21 and a rib part 22 formed on its outer peripheral surface. The flange part 21 extends in a flange shape radially outward from the outer peripheral surface at a downstream end of the pipe member 20. As illustrated in FIG. 4, a downstream end surface 21A of the flange part 21 has a flat shape along a direction orthogonal to the center axis of the pipe member 20. A flat packing P1 is attached to the downstream end surface 21A. The flat packing P1 constitutes the second opening/closing part 19 together with an upstream end 33A of a third cylinder part 33 to be described later. An upstream end surface 21B of the flange part 21 gently expands from the outer peripheral surface of the pipe member 20 to an outer peripheral edge of the flange part 21 so as to form an arc shape in cross section. With this configuration, the flange part 21 guides the raw water flowing through the raw water flow path 13 along the outer peripheral surface of the pipe member 20, radially outward. The flange part 21 is an example of a guide part according to the present disclosure. The flange part 21 guides the raw water flowing on the outer peripheral surface of the pipe member 20 along the axial direction of the pipe member 20, toward the first stream flow path 15A.

As illustrated in FIG. 5, the rib part 22 extends along the center axis of the pipe member 20. A plurality of the rib parts 22 is formed in a circumferential direction of the pipe member 20. The rib parts 22 straighten the raw water flowing through the raw water flow path 13. Each rib part 22 has a projecting part 22A. The projecting part 22A projects radially outward in the middle of the rib part 22. A washer W is attached to an upstream end surfaces of the projecting parts 22A. The washer W is in contact with one end of a coil spring S. The coil spring S has the other end in contact with a spring seat part 41A to be described later of the first inner cylinder member 41. With this configuration, the coil spring S applies, to the pipe member 20, an elastic force in a direction in which the pipe member 20 moves to the downstream side relative to the first inner cylinder member 41. A downstream end surface of the projecting part 22A comes into contact with an upper end surface of the second inner cylinder member 42.

As illustrated in FIG. 3, a buffer part 23, a flow straightening part 24, and an opening part 25 are provided in the pipe member 20 in this order from the upstream side. The buffer part 23 is provided at an upstream end of the pipe member 20. The buffer part 23 temporarily retains the reformed water flowing into the reformed water flow path 11 from the reformed water supply path 9, thereby reducing pulsation of the discharging water. The flow straightening part 24 is provided in the middle of the pipe member 20. The flow straightening part 24 straightens the reformed water flowing therethrough. The opening part 25 is formed at the downstream end of the pipe member 20. The opening part 25 constitutes the reformed water discharging part 12 of the water discharging device 10.

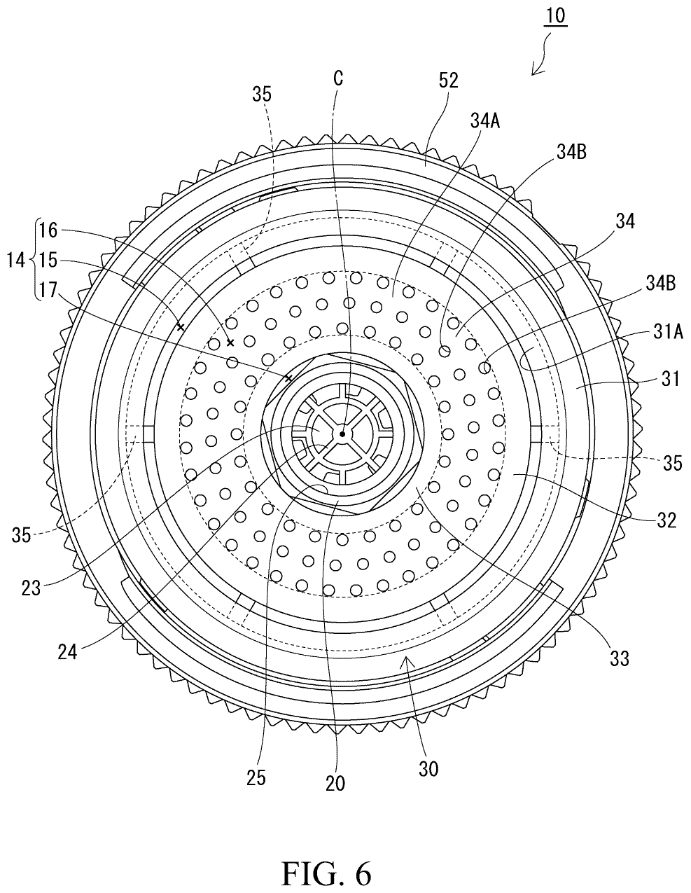

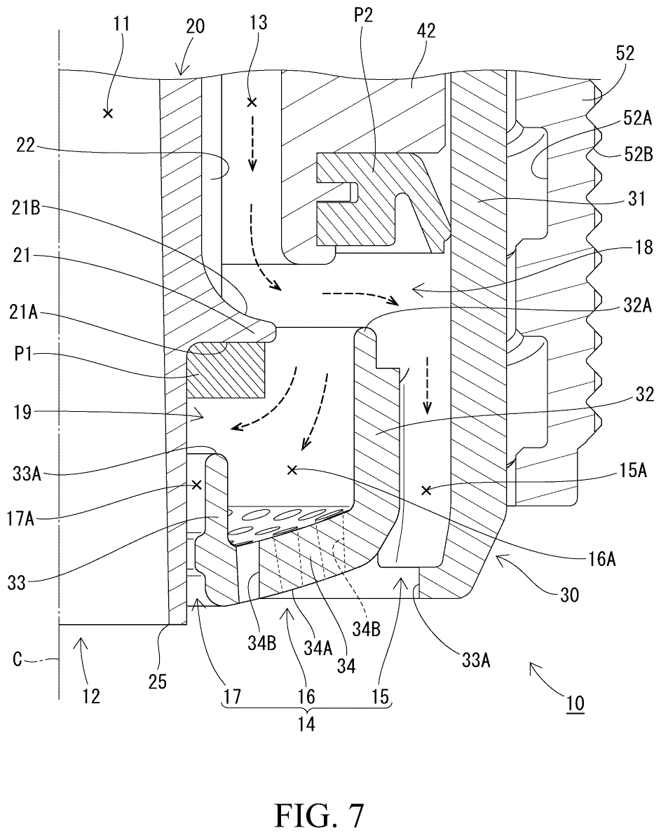

As illustrated in FIGS. 6 and 7, the water spraying member 30 is provided in the raw water discharging part 14 of the water discharging device 10. The water spraying member 30 is provided to move freely relative to the pipe member 20 in the direction along the axis S which is the same as the axis of the pipe member 20. In the water discharging device 10, the water spraying member 30 is moved in the direction of the axis S, whereby the water discharging form of the raw water discharged from the raw water discharging part 14 is switched between stream water discharge and spray water discharge.

As illustrated in FIGS. 6 and 7, the water spraying member 30 includes a first cylinder part 31, a second cylinder part 32, the third cylinder part 33, a water spraying part 34, and a connection rib 35. The first cylinder part 31, the second cylinder part 32, and the third cylinder part 33 each have a cylindrical shape. The first cylinder part 31, the second cylinder part 32, and the third cylinder part 33 are concentrically arranged.

Among the three cylinder parts 31, 32, and 33, the first cylinder part 31 is disposed on the outermost side. The first stream flow path 15A is formed on an inner peripheral surface side of the first cylinder part 31. The first cylinder part 31 has a reduced diameter part 31A, a protrusion 31B, and a cutout part 31C. The reduced diameter part 31A has a form obtained by bending a downstream end of the first cylinder part 31 inward in a hook shape in cross section. The reduced diameter part 31A is smaller in inner diameter than a portion of the first cylinder part 31 located above the reduced diameter part 31A. With this configuration, the reduced diameter part 31A guides the raw water flowing along the inner peripheral surface of the first cylinder part 31 forming the first stream flow path 15A, radially inward. The protrusion 31B is disposed in an internal thread part 52A (to be described later) formed on an inner peripheral surface of the second outer cylinder member 52. The protrusion 31B moves within the internal thread part 52A by a rotating operation of the second outer cylinder member 52.

As illustrated in FIG. 5, the cutout part 31C has a form obtained by cutting out an upstream end of the first cylinder part 31 in the axial direction. A plurality of the cutout parts 31C is provided in the circumferential direction of the first cylinder part 31. In each cutout part 31C, a protruding part 42A (to be described later) of the second inner cylinder member 42 is disposed. The cutout part 31C has a width slightly larger than a circumferential width of the protruding part 42A and a length sufficiently larger than an axial length of the protruding part 42A. Due to the action of the cutout parts 31C and the protruding parts 42A, the water spraying member 30 is allowed to move, relative to the second inner cylinder member 42, only in the axial direction and is prevented from rotating about the axis.

As illustrated in FIGS. 6 and 7, the second cylinder part 32 is disposed inside the first cylinder part 31. The second cylinder part 32 forms the first stream flow path 15A in a space between the second cylinder part 32 and the first cylinder part 31. An upstream end 32A of the second cylinder part 32 constitutes the first opening/closing part 18. When the water spraying member 30 moves to the upstream side in the axial direction, the upstream end 32A of the second cylinder part 32 comes into contact with a lip packing P2 to be described later, thereby closing the first stream flow path 15A.

The third cylinder part 33 is disposed on the innermost side among the three cylinder parts 31, 32, and 33. The downstream end of the pipe member 20 is inserted into the third cylinder part 33. A gap is formed between an inner peripheral surface of the third cylinder part 33 and the outer peripheral surface of the pipe member 20. This gap is the second stream flow path 17A communicating with the second stream water discharging part 17. The upstream end 33A of the third cylinder part 33 constitutes the second opening/closing part 19. When the water spraying member 30 moves to the upstream side in the axial direction, the upstream end 33A of the third cylinder part 33 comes into contact with the flat packing P1, thereby closing the second stream flow path 17A.

The water spraying part 34 has an annular shape that connects a downstream end of the second cylinder part 32 and a downstream end of the third cylinder part 33. The water spraying part 34 forms a water spraying surface 34A and a plurality of water spraying holes 34B. The water spraying surface 34A is exposed in the discharging direction of the raw water of the raw water discharging part 14. The plurality of water spraying holes 34B open up to the water spraying surface 34A. The plurality of water spraying holes 34B communicates, on the upstream side, with a spray flow path 16A which is continuous to the raw water flow path 13. The water spraying surface 34A is smoothly continued to an outer peripheral surface of the second cylinder part 32 on the outer peripheral side. The inner peripheral side of the water spraying surface 34A is smoothly continued to the inner peripheral surface of the third cylinder part 33. The water spraying surface 34A is inclined forward in the discharging direction of the raw water of the raw water discharging part 14 from the outer peripheral side toward the center.

The connection rib 35 connects the first cylinder part 31 and the second cylinder part 32. A plurality of the connection ribs 35 is provided in the circumferential direction at equal intervals.

As illustrated in FIGS. 3 and 5, the first inner cylinder member 41 and the second inner cylinder member 42 are each formed in a cylindrical shape. The first inner cylinder member 41 and the second inner cylinder member 42 are fixedly connected together in the axial direction such that the first inner cylinder member 41 is located on the upstream side and the second inner cylinder member 42 is located on the downstream side. The first inner cylinder member 41 and the second inner cylinder member 42, which are connected together, are locked in the axial direction by a retainer 43. The pipe member 20 is enclosed by the first inner cylinder member 41 and the second inner cylinder member 42. The first inner cylinder member 41 and the second inner cylinder member 42 are arranged coaxially with the pipe member 20. A gap between inner peripheral surfaces of the first inner cylinder member 41 and the second inner cylinder member 42 and the outer peripheral surface of the pipe member 20 functions as the raw water flow path 13.

As illustrated in FIG. 3, the first inner cylinder member 41 has the spring seat part 41A. The spring seat part 41A is formed by making a portion of the inner peripheral portion of the first inner cylinder member 41 smaller in diameter than the other portion. The other end of the coil spring S which applies an elastic force in the axial direction to the pipe member 20 comes into contact with the spring seat part 41A. As illustrated in FIG. 5, the second inner cylinder member 42 has the protruding part 42A. The protruding part 42A is formed to protrude from an outer peripheral surface of the second inner cylinder member 42. The protruding part 42A is disposed inside the cutout part 31C of the water spraying member 30.

As illustrated in FIGS. 4 and 5, the lip packing P2 is attached to a downstream end of the second inner cylinder member 42. The lip packing P2 is in contact, at its outer peripheral edge, with the inner peripheral surface of the first cylinder part 31 of the water spraying member 30 in a watertight manner. When the water spraying member 30 moves to the upstream side in the axial direction, the upstream end 32A of the second cylinder part 32 comes into contact with a downstream end surface of the lip packing P2.

As illustrated in FIGS. 3 and 5, the first outer cylinder member 51 and the second outer cylinder member 52 are each formed in a cylindrical shape. The first outer cylinder member 51 and the second outer cylinder member 52 are arranged outside the first inner cylinder member 41 and the second inner cylinder member 42. The first outer cylinder member 51 and the second outer cylinder member 52 are arranged in line in the axial direction such that the first outer cylinder member 51 is located on the upstream side and the second outer cylinder member 52 is located on the downstream side. The first outer cylinder member 51 is fixedly disposed relative to the first inner cylinder member 41.

As illustrated in FIGS. 4 and 5, the second outer cylinder member 52 is attached to the second inner cylinder member 42 by an E-shaped snap ring E. By the E-shaped snap ring E, the second outer cylinder member 52 is prevented from moving in the axial direction relative to the second inner cylinder member 42 but is allowed to rotate about the axis. Rotation of the second inner cylinder member 42 about the axis causes the water spraying member 30 to move in the axial direction. That is, the second inner cylinder member 42 functions as a switching operation part for switching the water discharging form of the raw water. Specifically, the internal thread part 52A is formed on the inner peripheral surface of the second inner cylinder member 42. The protrusion 31B formed on an outer peripheral surface of the water spraying member 30 is disposed in the internal thread part 52A. The second inner cylinder member 42 rotates about the axis, thereby moving the entire water spraying member 30 including the protrusion 31B in the axial direction. A knurled part 52B is formed on the outer peripheral surface of the second inner cylinder member 42. The knurled part 52B is a portion where a user of the water discharging device 10 puts his/her fingers to rotate the second outer cylinder member 52.

The operation of the water discharging device 10, configured as described above, will be described. In the water discharging device 10, when the reformed water operating part 80 is operated, the reformed water generator 120 generates reformed water. The reformed water generated by the reformed water generator 120 flows through the reformed water supply path 9 and is introduced into the reformed water flow path 11 located inside the pipe member 20. The reformed water introduced into the reformed water flow path 11 is buffered and straightened through the buffer part 23 and the flow straightening part 24, and then discharged from the reformed water discharging part 12.

When the raw water operating part 70 is operated, the water discharging device 10 feeds, as raw water, a mixture of hot water and cold water made by the mixing valve (not illustrated) to the raw water supply path 7. The raw water flowing through the raw water supply path 7 is introduced into the raw water flow path 13 and discharged from the raw water discharging part 14. The raw water discharging part 14 is disposed around the reformed water discharging part 12 so as to surround the reformed water discharging part 12. With this configuration, the water discharging device 10 has a neat and good appearance. Since the raw water discharging part 14 is disposed around the reformed water discharging part 12 in the water discharging device 10, water is discharged from the same place and in the same direction in both a case where the reformed water is discharged and a case where the raw water is discharged, thus achieving good usability.

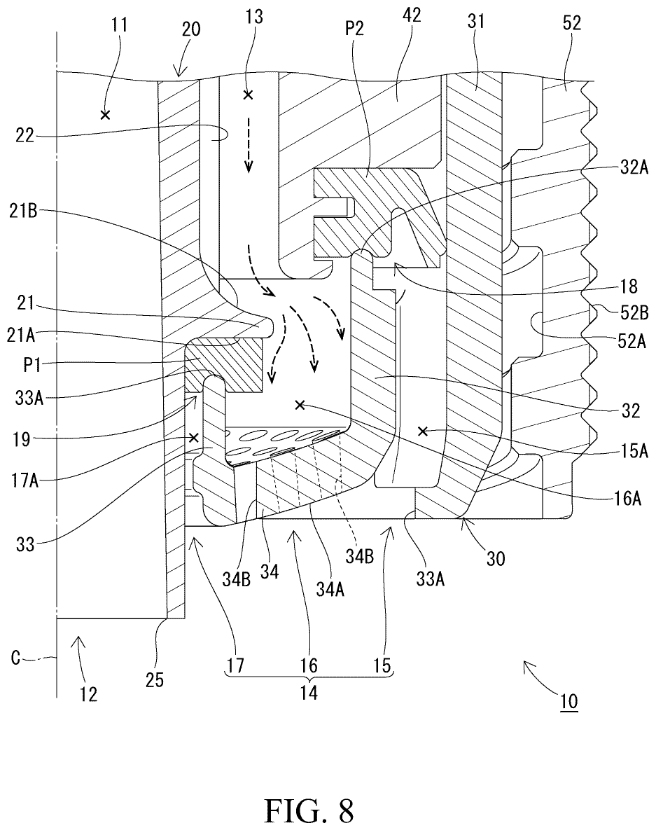

The water discharging device 10 can discharge water by switching the water discharging form of the raw water discharging part 14 between the spray form and the stream form. This switching is performed by opening/closing the first stream flow path 15A and the second stream flow path 17A by the first opening/closing part 18 and the second opening/closing part 19. The opening/closing of the first stream flow path 15A and the second stream flow path 17A is performed by rotating the second outer cylinder member 52 about the axis to move the water spraying member 30 in the axial direction. The water spraying member 30 moves in the axial direction between a first position illustrated in FIG. 7 and a second position illustrated in FIG. 8. The first position is a position where the water spraying member 30 has moved from the second position to the downstream side which is one side in the axial direction. On the other hand, the second position is a position where the water spraying member 30 has moved from the first position to the upstream side which is the other side in the axial direction.

In a state where the water spraying member 30 is at the first position illustrated in FIG. 7, the first opening/closing part 18 and the second opening/closing part 19 open the first stream flow path 15A and the second stream flow path 17A in the water discharging device 10. In this state, the water discharging device 10 discharges the raw water from the raw water discharging part 14 in the stream water discharging form. Specifically, in a state where the water spraying member 30 is at the first position, the raw water flow path 13 communicates with the stream water discharging parts 15 and 17 and the spray water discharging part 16. This allows the raw water flowing through the raw water flow path 13 to flow into the first stream flow path 15A, the spray flow path 16A, and the second stream flow path 17A. Among these flow paths 15A, 16A, and 17A, the first stream flow path 15A is a flow path communicating with the first stream water discharging part 15 which is the outermost in the raw water discharging part 14.

The first stream flow path 15A is formed between the first cylinder part 31 and the second cylinder part 32 of the water spraying member 30. The raw water flowing into the first stream flow path 15A flows along the outer peripheral surface of the second cylinder part 32. The outer peripheral surface of the second cylinder part 32 is smoothly connected to the water spraying surface 34A of the water spraying part 34 at the downstream end. The water spraying surface 34A extends toward the center to be inclined forward in the discharging direction of the raw water of the raw water discharging part 14. Therefore, the raw water flowing along the outer peripheral surface of the second cylinder part 32 flows further along the water spraying surface 34A of the water spraying part 34 due to the effect of surface tension. Thus, the raw water discharged from the first stream water discharging part 15 forms a flow going toward the center of the raw water discharging part 14 along the water spraying surface 34A.

Similarly, the raw water flowing through the first stream flow path 15A flows along the inner peripheral surface of the first cylinder part 31. The flowing direction of the raw water flowing along the inner peripheral surface of the first cylinder part 31 is changed by the reduced diameter part 31A at the downstream end of the first cylinder part 31 and guided toward the center of the raw water discharging part 14. In this way, the first stream water discharging part 15 forms a flow of the raw water going toward the center of the raw water discharging part 14.

These flows of the raw water sweep the raw water discharged from each of the spray water discharging part 16 and the second stream water discharging part 17 located closer to the center than the first stream water discharging part 15 and are joined together. The raw water thus joined forms stream water discharge. As described above, in a state where the first opening/closing part 18 and the second opening/closing part 19 open the stream flow paths 15A and 17A, respectively, the water discharging device 10 forms stream water discharge consisting of the raw water discharged from the stream water discharging parts 15 and 17 and the raw water discharged from the spray water discharging part 16 joined together.

As illustrated in FIG. 7, in a state where the water spraying member 30 is at the first position, the raw water flowing through the raw water flow path 13 is guided to the first stream flow path 15A by the flange part 21. Therefore, in a case where the water discharging form of the raw water discharged from the raw water discharging part 14 is the stream form, a sufficient flow of the raw water is supplied to the first stream flow path 15A in the water discharging device 10. Accordingly, a sufficient flow of the raw water is discharged from the first stream water discharging part 15 toward the center of the raw water discharging part 14, which allows the raw water discharged from the spray water discharging part 16 and the raw water discharged from the second stream water discharging part 17 to be suitably joined together.

On the other hand, in a state where the water spraying member 30 is at the second position illustrated in FIG. 8, the first opening/closing part 18 and the second opening/closing part 19 close the first stream flow path 15A and the second stream flow path 17A in the water discharging device 10. Specifically, when the water spraying member 30 moves from the first position to the upstream side which is the other side of the pipe member 20 in the axial direction and reaches the second position, the upstream end 32A of the second cylinder part 32 of the water spraying member 30 comes into contact with the flat packing P1 in a watertight manner, and the upstream end 33A of the third cylinder part 33 comes into contact with the lip packing P2 in a watertight manner. As a result, the first opening/closing part 18 and the second opening/closing part 19 close the first stream flow path 15A and the second stream flow path 17A. In this state, the water discharging device 10 discharges the raw water from the raw water discharging part 14 in the spray water discharging form.

In a state where the water spraying member 30 is at the second position, the raw water flow path 13 is not in communication with the first stream flow path 15A and the second stream flow path 17A and is in communication with only the spray water discharging part 16. Therefore, the raw water flowing through the raw water flow path 13 can flow into only the spray flow path 16A. Accordingly, the raw water flowing through the raw water flow path 13 passes through the spray flow path 16A and is discharged only from the plurality of water spraying holes 34B, thus forming spray water discharge. As described above, in the water discharging device 10, in a state where the first opening/closing part 18 and the second opening/closing part 19 close the stream flow paths 15A and 17A, respectively, the raw water discharged only from the spray water discharging part 16 forms spray water discharge.

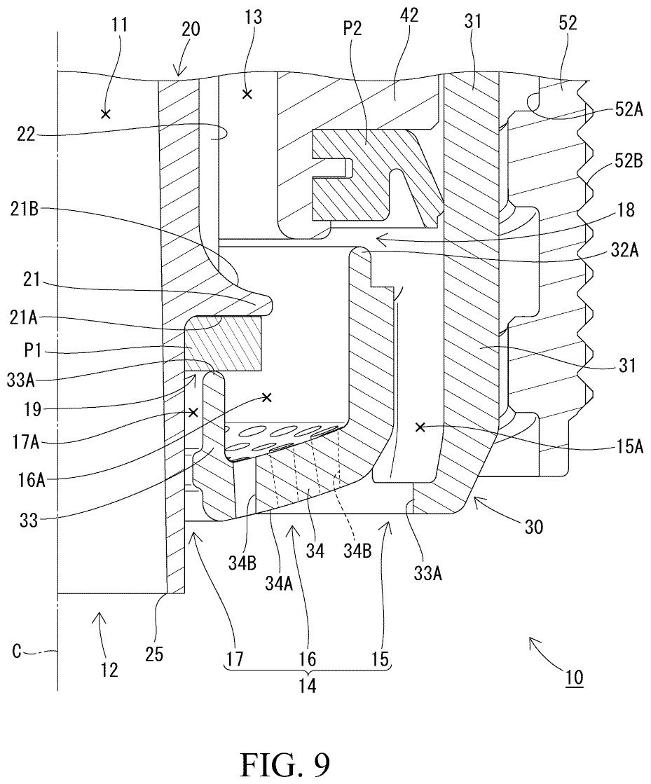

As illustrated in FIG. 9, in the course of the transition of the water spraying member 30 from the first position to the second position, the second opening/closing part 19 closes the second stream flow path 17A before the first opening/closing part 18 closes the first stream flow path 15A. As described above, the second opening/closing part 19 includes the upstream end 33A of the third cylinder part 33 of the water spraying member 30. The second opening/closing part 19 closes the second stream flow path 17A when the upstream end 33A of the third cylinder part 33 comes into contact with the flat packing P1. The pipe member 20 moves freely along the axial direction, and the coil spring S applies an elastic force in the axial direction to the pipe member 20. The upstream end 33A of the third cylinder part 33 of the water spraying member 30 is pressed on the flat packing P1 against the elastic force of the coil spring S. The water spraying member 30 moves further to the upstream side such that the upstream end 33A of the third cylinder part 33 pushes back the pipe member 20 to the upstream side together with the flat packing P1, and thereby the upstream end 32A of the second cylinder part 32 comes into contact with the downstream end surface of the lip packing P2.

That is, in the water discharging device 10, the water spraying member 30 moves the pipe member 20 to the upstream side while maintaining, by the elastic force of the coil spring S, the state where the upstream end 33A of the third cylinder part 33 and the flat packing P1 are in contact with each other, and causes the upstream end 32A of the second cylinder part 32 to come into contact with the downstream end surface of the lip packing P2. In this way, the water discharging device 10 can suitably achieve both the closing of the first stream flow path 15A by the first opening/closing part 18 and the closing of the second stream flow path 17A by the second opening/closing part 19.

As described above, the water discharging device 10 according to the first embodiment includes the raw water discharging part 14 and the reformed water discharging part 12. The raw water discharging part 14 can discharge the raw water supplied from the water supply source (not illustrated) through the water supply path 1 by switching the water discharging form between the spray form and the stream form. The reformed water discharging part 12 discharges the reformed water obtained by reforming the raw water. The raw water discharging part 14 is disposed around the reformed water discharging part 12 so as to surround the reformed water discharging part 12.

As described above, the water discharging device 10 can switch the water discharging form of the raw water discharging part 14 between the spray form and the stream form. The water discharging device 10 includes the reformed water discharging part 12 separately from the raw water discharging part 14. The water discharging device 10 can discharge water in a plurality of water discharging forms and also can discharge water selected from a plurality of types of water, thus having good convenience. In the water discharging device 10, the raw water discharging part 14 and the reformed water discharging part 12 are separately provided. This prevents the reformed water discharged from the reformed water discharging part 12 from mixing with the raw water, which ensures good quality. The reformed water discharging part 12 is surrounded by the raw water discharging part 14. This makes the water discharging device 10 compact as compared with a case where the discharging parts are arranged side by side in the front-back or left-right direction, and the like, or a case where the discharging parts are provided in separate water discharging devices. The water discharging device 10 can therefore suppress an increase in size while ensuring convenience and quality of the reformed water.

In the water discharging device 10, the raw water discharging part 14 includes the spray water discharging part 16 and the first stream water discharging part 15 as the stream water discharging part. The spray water discharging part 16 discharges the raw water when the water discharging form is the spray form. The first stream water discharging part 15 discharges the raw water when the water discharging form is the stream form. The first stream water discharging part 15 is disposed around the spray water discharging part 16 so as to surround the spray water discharging part 16. Thus, the spray water discharging part 16 and the first stream water discharging part 15 can be compactly arranged in the water discharging device 10.

In the water discharging device 10, the spray water discharging part 16 forms the water spraying surface 34A in which the plurality of water spraying holes 34B is formed. The water spraying surface 34A is a surface exposed in the discharging direction of the raw water of the raw water discharging part 14 and is inclined forward in the discharging direction from the outer peripheral side toward the center. The first stream water discharging part 15 is provided on the outer peripheral side of the spray water discharging part 16 and forms a flow of raw water going toward the center of the raw water discharging part 14 along the water spraying surface 34A. Thus, the raw water discharged from the first stream water discharging part 15 converges toward the center, thereby achieving well-formed stream water discharge.

The water discharging device 10 includes the first opening/closing part 18 as the opening/closing part. The first opening/closing part 18 opens/closes the first stream flow path 15A as the stream flow path communicating with the first stream water discharging part 15. In a state where the first opening/closing part 18 closes the first stream flow path 15A, the raw water discharging part 14 discharges the raw water only from the spray water discharging part 16, thereby forming spray water discharge. In a state where the first opening/closing part 18 opens the first stream flow path 15A, the raw water discharging part 14 forms stream water discharge consisting of the raw water discharged from the first stream water discharging part 15 and the raw water discharged from the spray water discharging part 16 joined together. In this way, the water discharging device 10 achieves stream water discharge using the water discharged from the spray water discharging part 16. Therefore, the water discharging device 10 can be made compact as compared with a case where the water discharging part for spray water discharge and the water discharging part for stream water discharge are completely switched.

The water discharging device 10 includes the water spraying member 30 and the pipe member 20. The water spraying member 30 has the plurality of water spraying holes 34B formed therein and constitutes the spray water discharging part 16. The pipe member 20 is provided to extend through the water spraying member 30 and has the reformed water discharging part 12 provided at a distal end of the pipe member 20. The water spraying member 30 is provided to move freely along the axial direction of the pipe member 20. The first stream water discharging part 15 is provided on the outer peripheral side of the water spraying member 30. The raw water discharging part 14 has the second stream water discharging part 17. The second stream water discharging part 17 is formed between the water spraying member 30 and the pipe member 20 and discharges the raw water when the water discharging form is the stream form. The water discharging device 10 includes the second opening/closing part 19 in addition to the first opening/closing part 18. The second opening/closing part 19 opens/closes the second stream flow path 17A communicating with the second stream water discharging part 17. The first opening/closing part 18 and the second opening/closing part 19 open the first stream flow path 15A and the second stream flow path 17A, respectively, when the water spraying member 30 moves to one side in the axial direction. The first opening/closing part 18 and the second opening/closing part 19 close the first stream flow path 15A and the second stream flow path 17A, respectively, when the water spraying member 30 moves to the other side in the axial direction. In this way, the water discharging device 10 can achieve stream water discharge using the water discharged from the gap between the water spraying member 30 and the pipe member 20. Since the second stream flow path 17A is closed by the second opening/closing part 19 during spray water discharge, the water discharging device 10 can achieve well-formed spray water discharge.

In the water discharging device 10, the second opening/closing part 19 closes the second stream flow path 17A before the first opening/closing part 18 closes the first stream flow path 15A. This allows the water discharging device 10 to achieve well-formed stream water discharge and spray water discharge.

For example, when the water discharge is switched from the stream water discharge to the spray water discharge, if the first stream water discharging part 15 is first shut off, water is discharged from the spray water discharging part 16 and the second stream water discharging part 17, and at this time, there is a possibility that it is erroneously recognized that the water discharge has been switched to the spray water discharge so that the switching operation is interrupted. On the other hand, when the second stream water discharging part 17 is first shut off, it is easy to recognize, while the water is continuously discharged from the first stream water discharging part 15, that the water discharge is the stream water discharge. Thus, in the water discharging device 10, the switching operation can be continued until the stream water discharge desired by the user occurs.

In this way, the water discharging device 10 can prompt the user to complete the switching operation from the stream water discharge to the spray water discharge, and since the complete switching operation is performed, well-formed stream water discharge and spray water discharge can be achieved.

In the water discharging device 10, the pipe member 20 moves freely along the axial direction, and an elastic force toward one side in the axial direction is applied to the pipe member 20. The second opening/closing part 19 closes the second stream flow path 17A when the water spraying member 30 moves to the other side in the axial direction so as to push back the pipe member 20 to the other side in the axial direction against the elastic force. In this way, in the water discharging device 10, the second opening/closing part 19 closes the second stream flow path 17A using the elastic force, and the pipe member 20 is moved in the axial direction while the closed state is maintained, so that the first opening/closing part 18 can reliably close the second stream flow path 17A. As a result, the first stream flow path 15A and the second stream flow path 17A can be reliably closed by the two opening/closing parts 18 and 19, and well-formed spray water discharge can be achieved in the water discharging device 10.

In the water discharging device 10, the pipe member 20 is provided with the flange part 21. The flange part 21 guides the raw water flowing through the raw water flow path 13 to the first stream flow path 15A as the stream flow path. That is, the flange part 21 functions as the guide part according to the present disclosure. This can make the flow of the raw water to the first stream flow path 15A sufficient in the water discharging device 10. This sufficient flow of the raw water flows toward the center along the water spraying surface 34A and sweeps the raw water discharged from the spray water discharging part to be joined together, so that well-formed stream water discharge can be achieved.

### Second Embodiment

A water discharging device according to a second embodiment is different from the water discharging device according to the first embodiment in that a water spraying member having a water spraying surface different in shape is provided. In the following description, the same components as those of the first embodiment are denoted by the same reference numerals to avoid the description from being redundant.

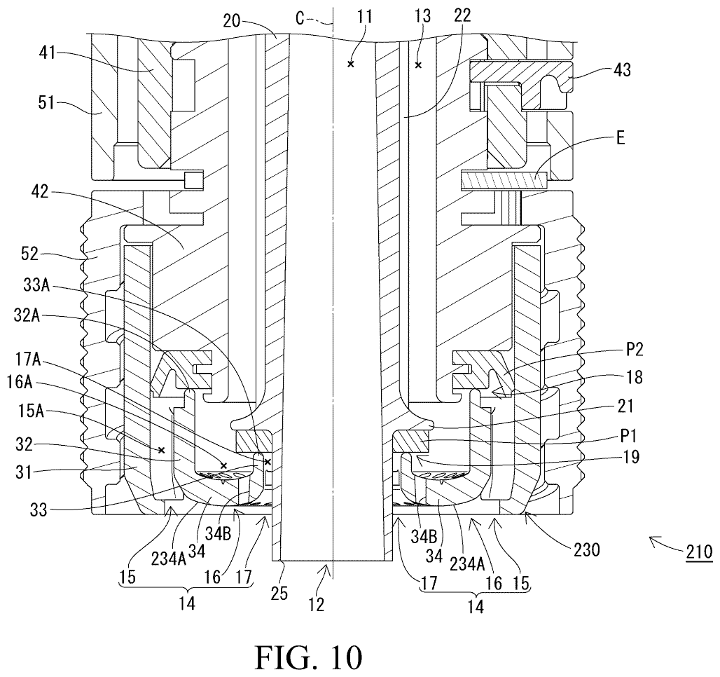

As illustrated in FIG. 10, a water discharging device 210 according to the second embodiment includes a water spraying member 230. In the water spraying member 230, a water spraying surface 234A is formed in a U-shape in cross section that bulges most in the discharging direction of the raw water at the center part between the second cylinder part 32 and the third cylinder part 33. In the water discharging device 210 including such a water spraying member 230, the first stream water discharging part 15 forms a flow of raw water going toward the center of the raw water discharging part 14 along the water spraying surface 234A. Also, the second stream water discharging part 17 forms a flow of raw water going toward the outside of the raw water discharging part 14 along the water spraying surface 234A.

As in the first embodiment, the water discharging device 210, configured as described above, can suppress an increase in size while ensuring convenience and quality of reformed water. In the water discharging device 210, the first stream water discharging part 15 and the second stream water discharging part 17 each discharge the raw water in a direction in which the flows of the raw water come into collision with each other, so that it is possible to reliably join the respective flows of the raw water from the stream water discharging parts 15 and 17 together. As a result, the water discharging device 210 can achieve more well-formed stream water discharge.

### Third Embodiment

A water discharging device according to a third embodiment is different from the water discharging device according to the first embodiment in that a seal member is provided between the pipe member and the water spraying member. In the following description, the same components as those of the first embodiment are denoted by the same reference numerals to avoid the description from being redundant.

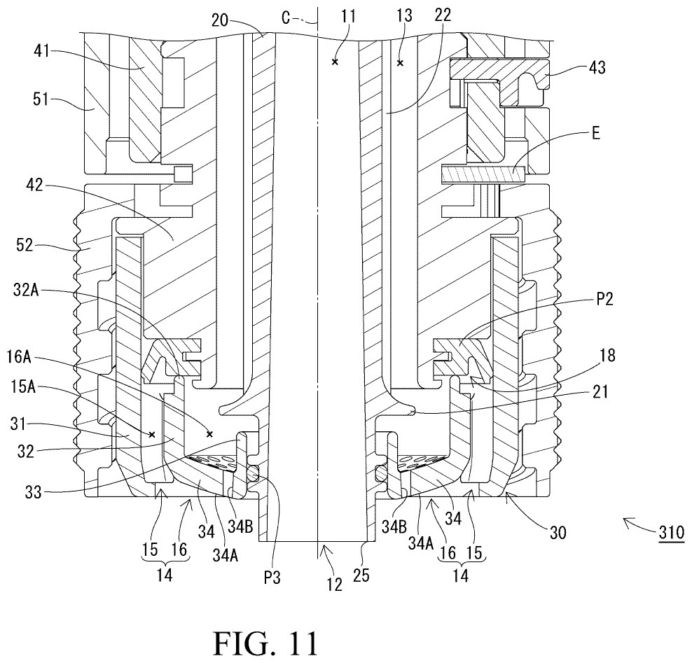

As illustrated in FIG. 11, a water discharging device 310 according to the third embodiment includes a seal member P3. The seal member P3 seals the gap between the outer peripheral surface of the pipe member 20 and the inner peripheral surface of the third cylinder part 33 of the water spraying member 30 in a watertight manner. That is, it can be said that the water discharging device 310 has no second stream water discharging part, and the first stream water discharging part 15 and the spray water discharging part 16 constitute the raw water discharging part 14. Not having a second stream water discharging part, the water discharging device 310 does not have a flow path communicating with the second stream water discharging part and also does not require a configuration for opening/closing the flow path such as the second opening/closing part. Not having a second opening/closing part, the water discharging device 310 also does not require a configuration in which the pipe member 20 moves freely in the axial direction, a configuration in which an elastic force is applied to the pipe member 20 in the axial direction, and the like.

As in the first embodiment, the water discharging device 310 configured as described above can suppress an increase in size while ensuring convenience and quality of reformed water. The water discharging device 310 is provided with the seal member P3 that seals the gap between the outer peripheral surface of the pipe member 20 and the inner peripheral surface of the third cylinder part 33 of the water spraying member 30 in a watertight manner, and thus no second stream water discharging part is formed. Accordingly, the water discharging device 310 does not require a configuration related to the second stream water discharging part. It is therefore possible to make the configuration of the water discharging device 310 simple.

### Fourth Embodiment

A water discharging device according to a fourth embodiment is different from the water discharging device according to the first embodiment in that a component corresponding to the water spraying member is integrated with the pipe member. In the following description, the same components as those of the first embodiment are denoted by the same reference numerals to avoid the description from being redundant.

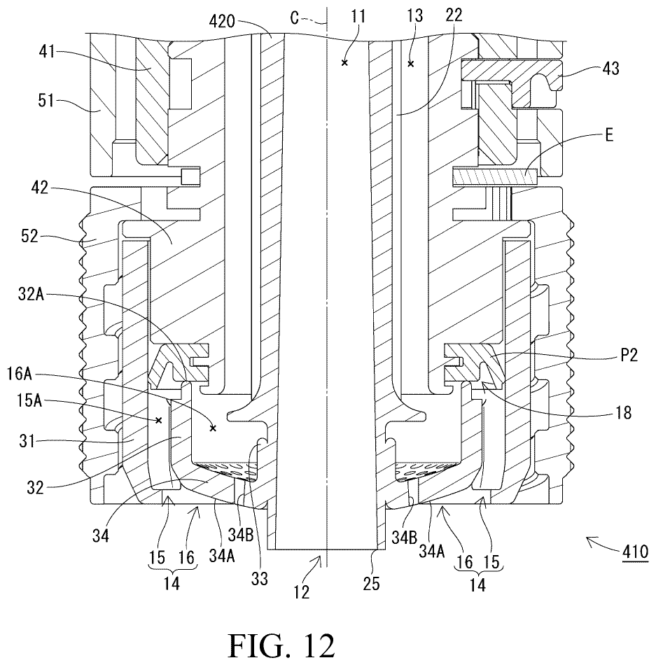

As illustrated in FIG. 12, a water discharging device 410 according to the fourth embodiment includes a pipe member 420. The pipe member 420 is integrally provided with a component corresponding to the water spraying member 30 according to the first embodiment. Specifically, the pipe member 420 has the same configuration as the first cylinder part 31, the second cylinder part 32, the third cylinder part 33, the water spraying part 34, and the connection rib 35 of the first embodiment. The pipe member 420 has a form in which the third cylinder part 33 is connected to an outer peripheral surface of a lower end of the pipe member 420. Thus, the water discharging device 410 has no components corresponding to the second stream water discharging part, the second stream flow path, and the second opening/closing part. In the water discharging device 410, as in the third embodiment, it can be said that the first stream water discharging part 15 and the spray water discharging part 16 constitute the raw water discharging part 14.

In a case of the water discharging device 410 of the fourth embodiment, when switching between the spray water discharge and the stream water discharge, the pipe member 420 entirely moves in the axial direction. This movement causes the first opening/closing part 18 to open/close the first stream flow path 15A. Having no second opening/closing part, the water discharging device 410 does not require a configuration for applying an elastic force to the pipe member in the axial direction, or the like.

As in the first embodiment, the water discharging device 410 configured as described above can suppress an increase in size while ensuring convenience and quality of reformed water. The water discharging device 410 includes the pipe member 420 integrated with a component corresponding to the water spraying member, and thus no second stream water discharging part is formed, so that a configuration related to the second stream water discharging part is not required. It is therefore possible to make the configuration of the water discharging device 410 simple.

### Fifth Embodiment

A water discharging device according to a fifth embodiment is different from the water discharging device of each of the above-described embodiments in the mechanism used to switch between the spray water discharge and the stream water discharge. In the following description, the same components as those of the above-described embodiments are denoted by the same reference numerals to avoid the description from being redundant.

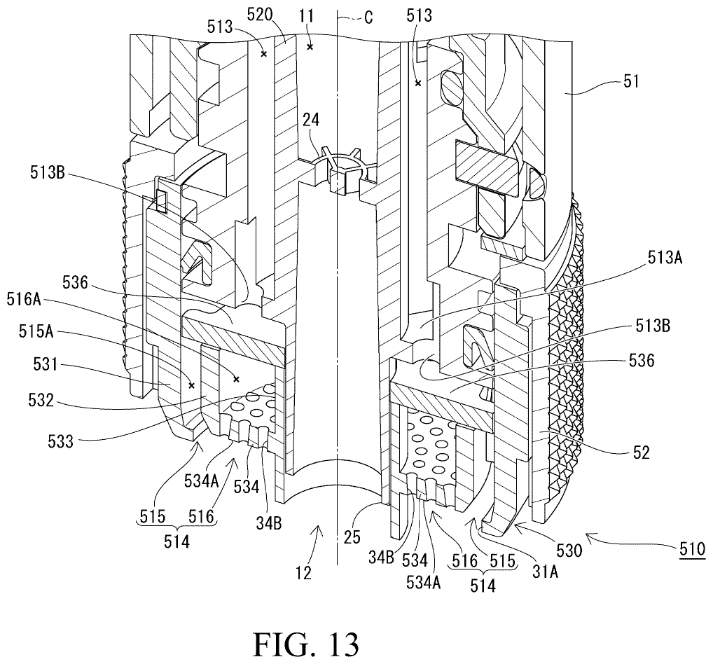

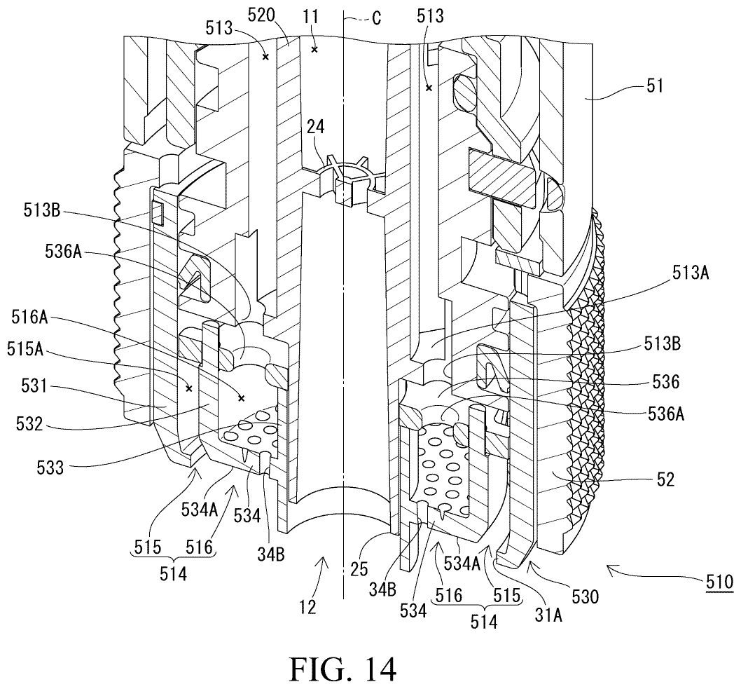

As illustrated in FIGS. 13 and 14, a water discharging device 510 according to the fifth embodiment includes a raw water discharging part 514. The raw water discharging part 514 is disposed around the reformed water discharging part 12 so as to surround the reformed water discharging part 12. The raw water discharging part 514 includes a stream water discharging part 515 and a spray water discharging part 516. The stream water discharging part 515 is disposed around the spray water discharging part 516 so as to surround the spray water discharging part 516.

The water discharging device 510 includes a water spraying member 530 and a pipe member 520. The pipe member 520 has a cylindrical shape with the reformed water flow path 11 formed therein. The pipe member 520 has the reformed water discharging part 12 provided at a distal end of the pipe member 520. The pipe member 520 is provided to extend through the water spraying member 530. A raw water flow path 513 is formed on an outer peripheral surface side of the pipe member 520. A downstream end of the raw water flow path 513 is closed by a closing plate part 513A. The closing plate part 513A has a communication hole 513B formed therethrough. The raw water flowing through the raw water flow path 513 can flow to the downstream side only through the communication hole 513B. A plurality of the communication holes 513B is formed around the axis C at equal intervals.

The water spraying member 530 is provided in the raw water discharging part 514 of the water discharging device 510. The water spraying member 530 is provided to rotate freely relative to the pipe member 520 about the axis C which is the same as the axis of the pipe member 520. The water spraying member 530 is rotated about the axis C, whereby the water discharging device 510 switches the water discharging form of the raw water discharged from the raw water discharging part 514 between the stream water discharge and the spray water discharge.

The water spraying member 530 includes a first cylinder part 531, a second cylinder part 532, a third cylinder part 533, and a water spraying part 534. The first cylinder part 531, the second cylinder part 532, and the third cylinder part 533 each have a cylindrical shape. In the water spraying member 530, the first cylinder part 531, the second cylinder part 532, and the third cylinder part 533 are concentrically arranged in this order from the outside. The first cylinder part 531 and the second cylinder part 532 are arranged with a space therebetween and connected by a connection rib (not illustrated). A gap between the first cylinder part 531 and the second cylinder part 532 is a stream flow path 515A. A space between the second cylinder part 532 and the third cylinder part 533 is a spray flow path 516A. The third cylinder part 533 is connected to a downstream end of the second cylinder part 532 by the water spraying part 534. A downstream end of the third cylinder part 533 extends to the downstream side beyond a downstream end of the pipe member 520. The water spraying part 534 has a water spraying surface 534A. The water spraying surface 534A has a flat shape extending in a direction orthogonal to the axis C.

A perforated plate 536 is attached to the water spraying member 530. The perforated plate 536 functions as the guide part according to the present disclosure. The perforated plate 536 has a disk shape formed with an outer diameter equal to an outer diameter of the first cylinder part 531. The perforated plate 536 is attached to an upstream end of the water spraying member 530 so as to close the spray flow path 516A from the upstream side. The perforated plate 536 is attached to the water spraying member 530 so as not to be movable relative to the water spraying member 530. As illustrated in FIG. 14, the perforated plate 536 has a through hole 536A formed therethrough. A plurality of the through holes 536A is formed around the axis C at equal intervals with the same number as the communication holes 513B and with the same pitch diameter as the communication holes 513B.

The water spraying member 530 is connected to the second outer cylinder member 52 on the outer peripheral surface side of the first cylinder part 531. Accordingly, the water spraying member 530 rotates about the axis C in response to rotation operation of the second outer cylinder member 52. Since the perforated plate 536 is attached to the water spraying member 530 so as not to be movable relative to the water spraying member 530, the perforated plate 536 rotates along with the rotation of the water spraying member 530 about the axis C. This changes the positions of the plurality of through holes 536A formed through the perforated plate 536 around the axis C.

The water spraying member 530 rotates freely about the axis C between a first position illustrated in FIG. 13 and a second position illustrated in FIG. 14. In the water discharging device 510, in a state where the water spraying member 530 is at the first position, the positions of the plurality of through holes 536A of the perforated plate 536 around the axis C are not aligned with the positions of the plurality of communication holes 513B around the axis C. When the positions of the plurality of through holes 536A of the perforated plate 536 around the axis C are not aligned with the positions of the plurality of communication holes 513B around the axis C, the water discharging device 510 can cause the raw water ejected from the communication holes 513B to collide with the perforated plate 536 to introduce the raw water into the stream flow path 515A on the outer peripheral side. That is, the raw water ejected from the communication holes 513B is guided to the stream flow path 515A by the perforated plate 536. In this way, the water discharging device 510 discharges the raw water from the raw water discharging part 514 in the stream water discharging form.

In the water discharging device 510, in a state where the water spraying member 530 is at the second position, the positions of the plurality of through holes 536A of the perforated plate 536 around the axis C are aligned with the positions of the plurality of communication holes 513B around the axis C. When the positions of the plurality of through holes 536A of the perforated plate 536 around the axis C are aligned with the positions of the plurality of communication holes 513B around the axis C, the water discharging device 510 can introduce the raw water ejected from the communication holes 513B into the spray flow path 516A on the downstream side through the through holes 536A. In this way, the water discharging device 510 discharges the raw water from the raw water discharging part 514 in the spray water discharging form.

As in the first embodiment, the water discharging device 510 configured as described above can suppress an increase in size while ensuring convenience and quality of reformed water. The water discharging device 510 can switch between spray water discharge and stream water discharge without providing an opening/closing part or the like. It is therefore possible to make the configuration of the water discharging device 510 simple.

### Sixth Embodiment

A water discharging device according to a sixth embodiment is different from the water discharging device of each of the above-described embodiments in the arrangement of the spray water discharging part and the stream water discharging part in the raw water discharging part. In the following description, the same components as those of the above-described embodiments are denoted by the same reference numerals to avoid the description from being redundant.

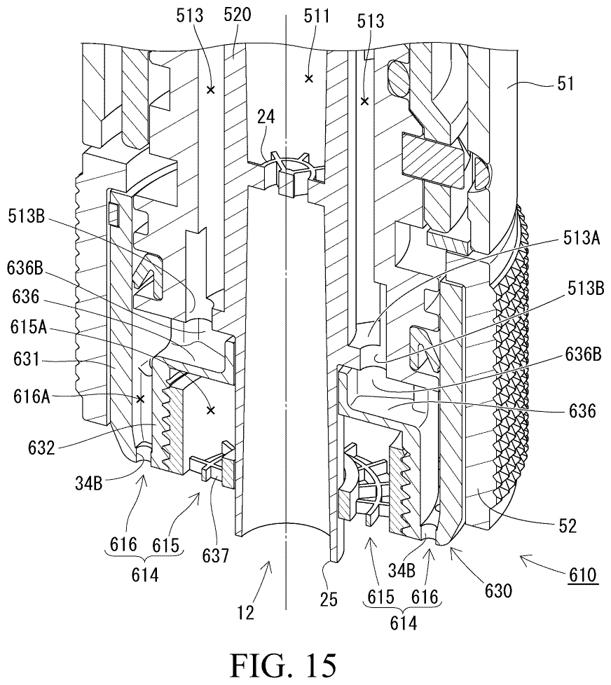

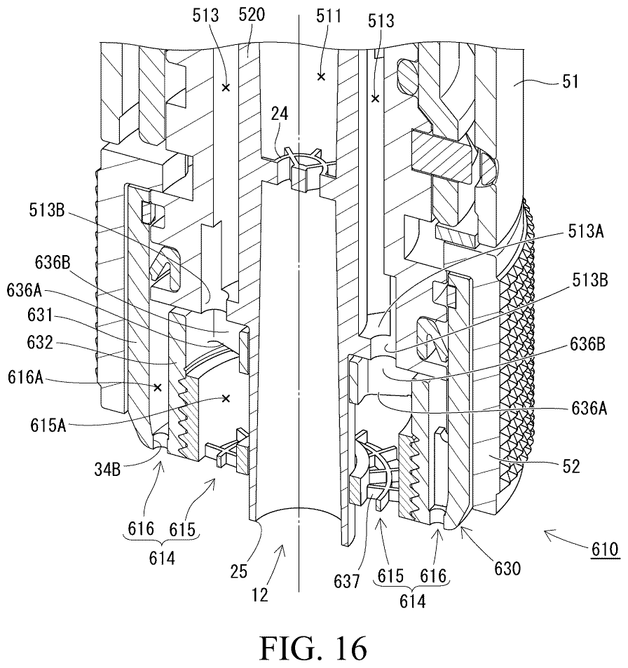

As illustrated in FIGS. 15 and 16, a water discharging device 610 according to the sixth embodiment includes a raw water discharging part 614. The raw water discharging part 614 is disposed around the reformed water discharging part 12 so as to surround the reformed water discharging part 12. The raw water discharging part 614 includes a stream water discharging part 615 and a spray water discharging part 616. In the raw water discharging part 614, the stream water discharging part 615 is disposed closer to the axis C than the spray water discharging part 616. That is, in the raw water discharging part 614, the spray water discharging part 616 is disposed around the stream water discharging part 615 so as to surround the stream water discharging part 615.

The water discharging device 610 includes a water spraying member 630 and the pipe member 520 as in the fifth embodiment. The water spraying member 630 is provided in the raw water discharging part 614 of the water discharging device 610. The water spraying member 630 is provided to rotate freely relative to the pipe member 520 about the axis C which is the same as the axis of the pipe member 520. The water spraying member 630 is rotated about the axis C by rotation operation of the second outer cylinder member 52, whereby the water discharging device 610 switches the water discharging form of the raw water discharged from the raw water discharging part 614 between stream water discharge and spray water discharge. In the water discharging device 610, the water spraying member 630 is similar to the water spraying member 530 of the fifth embodiment in that the water spraying member 630 is rotated about the axis C to switch the water discharging form of the raw water.

In the water spraying member 630, a gap between the first cylinder part 631 and the second cylinder part 632 is a spray flow path 616A. A water spraying part 634 is provided between the first cylinder part 631 and the second cylinder part 632. A space between the second cylinder part 632 and the outer peripheral surface of the pipe member 520 is a stream flow path 615A. A flow straightening member 637, which is separate from the water spraying member 630 for reasons of molding, is attached in the space forming the stream flow path 615A.

The water spraying member 630 is provided with a baffle plate part 636. The baffle plate part 636 functions as the guide part according to the present disclosure. The baffle plate part 636 is provided at an upstream end of the water spraying member 630 so as to cover the stream flow path 615A. As illustrated in FIG. 16, a plurality of fan-shaped openings 636A is formed through the baffle plate part 636 around the axis C at equal intervals in the circumferential direction. The openings 636A are formed as many as the communication holes 513B. A partition part 636B rises from a peripheral edge of each opening 636A along the axial direction.

The water spraying member 630 is connected to the second outer cylinder member 52 on the outer peripheral surface side of the first cylinder part 631. Accordingly, the water spraying member 630 rotates about the axis C in response to rotation operation of the second outer cylinder member 52. Since the baffle plate part 636 is attached to the water spraying member 630 so as not to be movable relative to the water spraying member 630, the baffle plate part 636 rotates along with the rotation of the water spraying member 630 about the axis C. This changes the positions of the plurality of openings 636A formed through the baffle plate part 636 around the axis C.

The water spraying member 630 rotates freely about the axis C between a first position illustrated in FIG. 15 and a second position illustrated in FIG. 16. In the water discharging device 610, in a state where the water spraying member 630 is at the first position, the downstream side of the communication hole 513B is covered by the baffle plate part 636. In this state, the water discharging device 610 causes the raw water colliding with the baffle plate part 636 to flow into the spray flow path 616A on the outer peripheral side. In this way, the water discharging device 610 discharges the raw water from the raw water discharging part 614 in the spray water discharging form.

In the water discharging device 610, in a state where the water spraying member 630 is at the second position illustrated in FIG. 16, the positions of the plurality of openings 636A of the baffle plate part 636 around the axis C are aligned with the positions of the plurality of communication holes 513B around the axis C. When the positions of the plurality of openings 636A of the baffle plate part 636 around the axis C are aligned with the positions of the plurality of communication holes 513B around the axis C, the water discharging device 610 can introduce the raw water ejected from the communication holes 513B into the stream flow path 615A on the downstream side through the openings 636A. That is, the raw water ejected from the communication holes 513B is guided to the stream flow path 615A by the baffle plate part 636. In this way, the water discharging device 610 discharges the raw water from the raw water discharging part 614 in the stream water discharging form.

As in the first embodiment, the water discharging device 610 configured as described above can suppress an increase in size while ensuring convenience and quality of reformed water. The water discharging device 610 can switch between spray water discharge and stream water discharge without providing an opening/closing part or the like. It is therefore possible to make the configuration of the water discharging device 610 simple.

The present disclosure is not limited to the embodiments described with reference to the above description and drawings, and for example, the following embodiments also fall within the technical scope.

The reformed water according to the present disclosure is not limited to the purified water exemplified in each of the above-described embodiments. The reformed water may be, for example, alkaline ionized water, carbonated water, or the like.

The water discharging device according to the present disclosure may be attached to the water discharging pipe such that the water discharging device cannot be pulled out from the water discharging pipe. The connection form between the water discharging device and the water discharging pipe is not limited to the connection forms of each of the above-described embodiments. The shape, size, and the like of the water discharging pipe to which the water discharging device is attached are not particularly limited.

The form of the switching operation when switching the water discharging form of the raw water discharging part is not limited to the form of each of the above-described embodiments.

It is not essential that the water discharging device include the guide part.

1. A water discharging device comprising:
a raw water discharging part capable of discharging raw water supplied from a water supply source by switching a water discharging form between a spray form and a stream form; and
a reformed water discharging part that discharges reformed water obtained by reforming the raw water, wherein
the raw water discharging part is disposed around the reformed water discharging part so as to surround the reformed water discharging part.

2. The water discharging device of claim 1, wherein
the raw water discharging part includes a spray water discharging part that discharges the raw water when the water discharging form is the spray form, and a stream water discharging part that discharges the raw water when the water discharging form is the stream form, and
the stream water discharging part is disposed around the spray water discharging part so as to surround the spray water discharging part.

3. The water discharging device of claim 2, wherein
the spray water discharging part forms a water spraying surface in which a plurality of water spraying holes is formed,
the water spraying surface is a surface exposed in a discharging direction of the raw water of the raw water discharging part, the water spraying surface being inclined forward in the discharging direction from an outer peripheral side toward a center, and
the stream water discharging part is provided on an outer peripheral side of the spray water discharging part and forms a flow of the raw water going toward the center of the raw water discharging part along the water spraying surface.

4. The water discharging device of claim 2, further comprising an opening/closing part configured to open and/or close a stream flow path communicating with the stream water discharging part, wherein
in a state where the opening/closing part closes the stream flow path, the raw water discharging part discharges the raw water only from the spray water discharging part, thereby forming spray water discharge, and
in a state where the opening/closing part opens the stream flow path, the raw water discharging part forms stream water discharge consisting of the raw water discharged from the stream water discharging part and the raw water discharged from the spray water discharging part joined together.

5. The water discharging device of claim 4, further comprising:
a water spraying member in which a plurality of water spraying holes are formed and that constitutes the spray water discharging part; and
a pipe member having a tubular shape provided to extend through the water spraying member, the pipe member including the reformed water discharging part provided at a distal end of the pipe member, wherein
the water spraying member is provided to move freely along an axial direction of the pipe member,
the stream water discharging part is a first stream water discharging part provided on an outer peripheral side of the water spraying member,
the raw water discharging part includes a second stream water discharging part formed between the water spraying member and the pipe member, the second stream water discharging part discharging the raw water when the water discharging form is the stream form, and
the opening/closing part is a first opening/closing part that is configured to open and/or close a first stream flow path serving as the stream flow path,
the water discharging device comprises a second opening/closing part that is configured to open and/or close a second stream flow path communicating with the second stream water discharging part, and
the first opening/closing part and the second opening/closing part open the first stream flow path and the second stream flow path, respectively, when the water spraying member moves to a downstream side in the axial direction and close the first stream flow path and the second stream flow path, respectively, when the water spraying member moves to an upstream side in the axial direction.

6. The water discharging device of claim 5, wherein
the second opening/closing part closes the second stream flow path before the first opening/closing part closes the first stream flow path.

7. The water discharging device of claim 5, wherein
the pipe member moves freely along the axial direction, an elastic force toward the downstream side in the axial direction being applied to the pipe member, and
the second opening/closing part closes the second stream flow path when the water spraying member moves to the upstream side in the axial direction so as to push back the pipe member to the upstream side in the axial direction against the elastic force.

8. The water discharging device of claim 4, further comprising a guide part that guides the raw water to the stream flow path.
